(19) United States
(12) Patent Application Publication
(10) Pub. No.: US 2006/0294040 A1
(43) Pub. Date: Dec. 28, 2006

(54) Method for using, adding and removing category in directory by documents

(76) Inventor: Ning Zhu, Miami, FL (US)

Correspondence Address: Ning Zhu, 12242 SW 143 Lane, Miami, FL, 33186-9999, US

(21) Appl. No.: 11/129,534

(22) Filed: May 16, 2005

(51) Int. Cl. G06F 17/30

(52) U.S. Cl. 707/1

(57) ABSTRACT

A method maintains a directory for documents. Each document has a category, and each document can add new category to the directory, and can vote to support or remove a category. The method is particularly useful in enhancing the scale of directory service.

### CROSS-REFERENCE TO RELATED APPLICATIONS

This application is based on and claims priority to U.S. Provisional Application Ser. No. 60/569,993, filed May. 11, 2004, which is herein incorporated by reference in its entirety.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

Searching on the Internet is very important now. But Internet directory service are very limited. Most of them are maintained by human being. A lot of web sites can't be listed. Search engine is not good enough yet. Even Google(http://www.google.com) with PageRank needs to improve to get subject specific results.

### BRIEF SUMMARY OF THE INVENTION

The present invention provides a directory service for web pages. It let the web pages to add, vote to remove, support categories in directory. Each of web pages can have one category. This is done by putting the category information into web page it self.

A crawler will get those information from web pages periodically.

In this way, it's hard for a web page to spam the directory. Because other web pages may vote to remove it's categories and itself.

The present invention also provides a method to score the categories. So the categories can be listed in order of score.

### BRIEF DESCRIPTION OF THE SEVERAL VIEWS OF THE DRAWING

FIG. 1 shows how to add a category into a directory service.

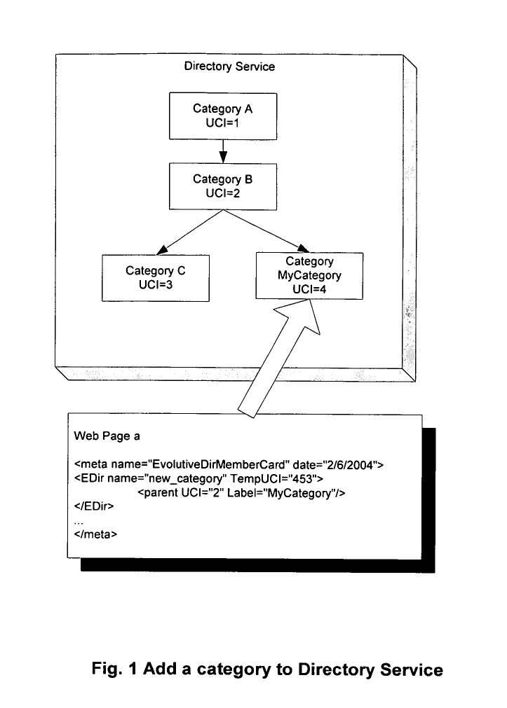

FIG. 2 shows how to vote to remove a category from a directory service.

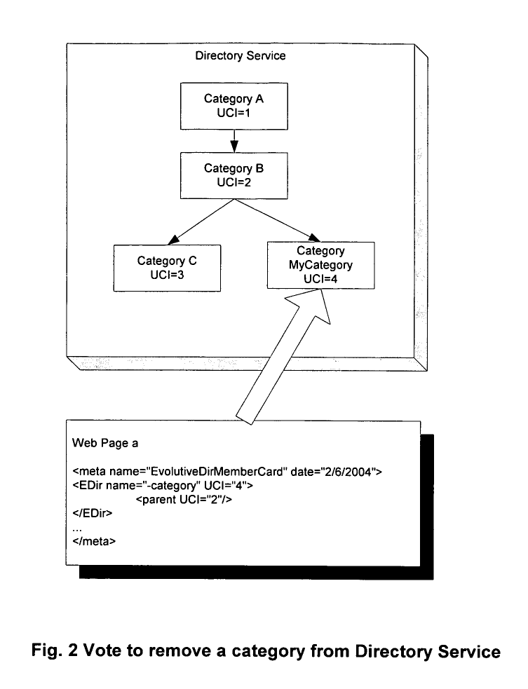

FIG. 3 shows how to vote to support a category in a directory service.

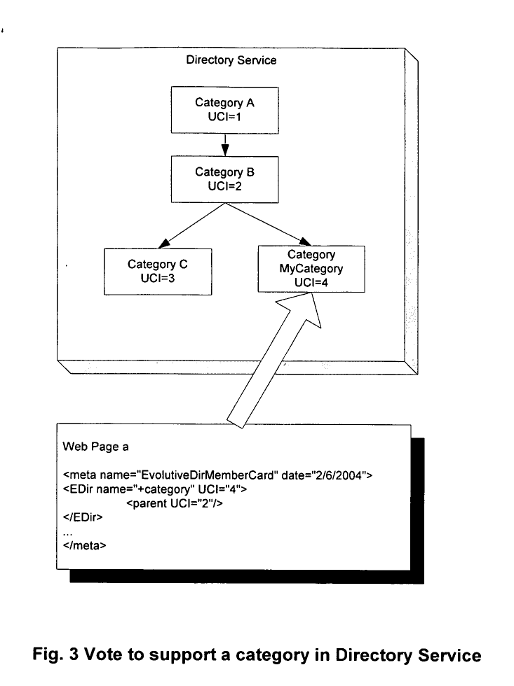

FIG. 4 shows how to use a category in a directory service.

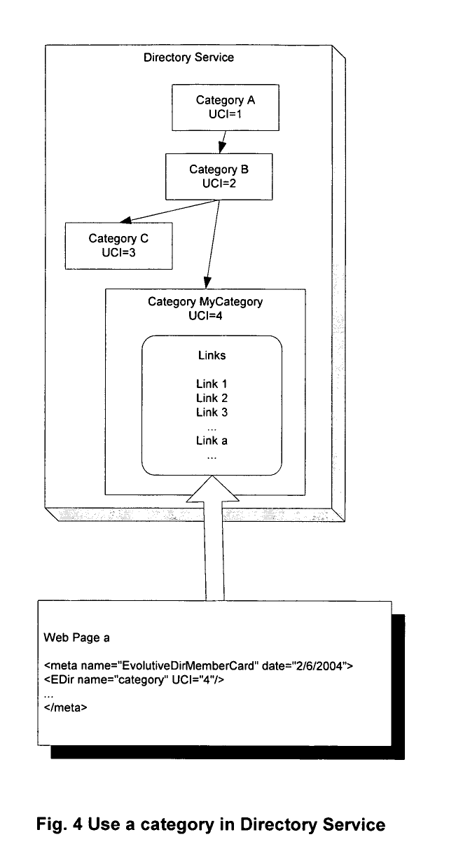

### DETAILED DESCRIPTION OF THE INVENTION

The followings are detailed description of the preferred embodiments.

Add a category:

A web page can include follow in it's header to add a category to directory.

```
<meta name=“EvolutiveDirMemberCard” date=“2/6/2004”>
<EDir name=“new_category” TempUCI=“453”>
  <parent UCI=“ABC” Label=“AAA”/>
  <parent UCI=“CDE” Label=“bbb”/>
  <parent UCI=“FGH” Label=“ccc”/>
  <parent UCI=“HIJ” Label=“ddd”/>
</EDir>
...
</meta>
```

Use a category:

A web page can include follow in it's header to use a category.

<meta name=“EvolutiveDirMemberCard” date=“2/6/2004”>
<EDir name=“category” UCI=“453”/>
...
</meta>

Vote to remove a category:

A web page can include follow in it's header to vote to remove a category.

```
<meta name=“EvolutiveDirMemberCard” date=“2/6/2004”>
<EDir name=“−category” UCI=“453”>
  <parent UCI=“ABC”/>
  <parent UCI=“CDE”/>
</EDir>
...
</meta>
```

Vote to support a category:

A web page can include follow in it's header to vote to support a category.

```
<meta name=“EvolutiveDirMemberCard” date=“2/6/2004”>
<EDir name=“+category” UCI=“453”>
  <parent UCI=“ABC”/>
  <parent UCI=“CDE”/>
</EDir>
...
</meta>
```

Vote to remove a link to web page:

A web page can include follow in it's header to vote to remove a link to web page.

<meta name=“EvolutiveDirMemberCard” date=“2/6/2004”>
<EDir name=“−page” UCI=“453” content=“www.abcabcabcabc.com”/>
...
</meta>

We claim:

1. A method using a directory for documents, comprising:
a) said directory comprising categories;
b) adding a category to said directory by said document;
c) using a said category in said directory by said document.

2. The method of claim 1 in which said adding a category comprising:
including category information of said category in said document.

3. The method of claim 1 in which said using a category comprising:
including category information of said category in said document.

4. The method of claim 1 further comprising:
assigning an unique identifier (Unified Category Identifier, UCI) to new category.

5. The method of claim 1 further comprising:
a) voting to remove a said category by said documents;
b) voting to support a said category by said documents.

6. The method of claim 5 in which said voting comprising:
including category information of said category in said document.

7. The method of claim 5 in which said voting comprising:
a) identifying a weighting factor for said document, the weighting factor being dependent on the rank of said document, and
b) adjusting said voting value based on the identified weighting factor.

8. The method of claim 5 in which said voting comprising:
a) identifying a weighting factor for said document, the weighting factor being dependent on the link to said directory from said document, and
b) adjusting said voting value based on the identified weighting factor.

9. The method of claim 1 further comprising:
voting to prevent a document from using a said category by said documents.

10. The method of claim 9 in which said voting comprising:
including category information of said category in said document.

11. The method of claim 1 further comprising:
assigning a score to each of the categories based on scores of sub-categories and documents using it.

12. The method of claim 5 further comprising:
removing said category when voting to remove > voting to support.

13. The method of claim 9 further comprising:
disabling said category for said document when said voting >0.
